(19) United States
(12) Patent Application Publication
(10) Pub. No.: US 2004/0141004 A1
(43) Pub. Date: Jul. 22, 2004

(54) Electronic messaging system and method with automatic prompting

(75) Inventors: Rafael Graniello Cabezas, Austin, TX (US); Jason Eric Moore, Austin, TX (US); Lilian Orozco, Del Valle, TX (US); Elizabeth Silvia, Austin, TX (US)

Correspondence Address: DUKE W. YEE, CARSTENS, YEE & CAHOON, L.L.P., P.O. BOX 802334, DALLAS, TX, 75380, US

(73) Assignee: International Business Machines Corporation, Armonk, NY

(21) Appl. No.: 10/347,837

(22) Filed: Jan. 17, 2003

(51) Int. Cl. G09G 5/00

(52) U.S. Cl. 345/751; 345/809; 345/752

(57) ABSTRACT

An improved system and method for users to communicate with one another via electronic messaging. An email message having one or more inquiries/questions or other type of solicitation is sent from an originator, and directed to one or more recipients. Upon receipt, the email message is opened by the recipient(s). The email message has an action button or similar indicator adjacent to an inquiry/question in the received email, the action button indicating that a response is being solicited by the originator. The recipient mouse clicks or otherwise selects the action button, which causes a template to be displayed in the same window as the received email. The recipient is thus able to quickly and easily provide a response in this template, and then send the response to the originator. In addition, if any template response field is left blank, either intentionally or inadvertently, the system automatically prompts the user to supply to missing response, or to confirm that the user does not intend to provide a response.

### BACKGROUND OF THE INVENTION

1. Technical Field

The present invention is related to electronic messaging systems, and more particularly to an electronic mail messaging system commonly referred to as email having improved usability characteristics.

2. Description of Related Art

As the cost of computer systems has dropped, their presence and use is becoming more ubiquitous in today's society. In the past, computer usage was generally limited to the business sector, but today computer usage has expanded into the home, automobile, cellular telephones, and other hand held devices such as personal digital assistants. With this expanded use of computers, electronic messaging using such computers is increasingly becoming a popular way to quickly communicate with other computer users. A popular type of electronic messaging known as email is commonly being used by individuals to communicate with others worldwide.

A typical email system has an inbox which stores copies of received emails. Highlighting or mouse clicking on an item in the inbox opens the email message and displays both the email message itself as well as other pertinent information such as the person who sent the email, the subject of the email, the date and time the email was sent, etc. In order to respond to a received email, the receiving user will typically click a REPLY button, which will cause a new email screen to appear. The user then types in their email response into this new email screen, and hits a SEND key to send the response email to the original sender.

One problem with such an email system is that the response to the original email is generally sent as a new, separate email. The original email message may or may not be appended at the end of the new email response. If the original email contained numerous inquiries or questions, it is sometimes difficult to correlate answers in the response email to the inquiries/questions in the original email.

One solution to this question/answer correlation problem is for the responding user to cut and paste the original email message into the new response email message, and then provide an answer to each of these pasted questions into this new response email message. This is a rather tedious and cumbersome solution. The present invention is directed to an improved way for a user to respond to electronic messaging inquiries/questions and other types of solicitation.

### SUMMARY OF THE INVENTION

The present invention is directed to an improved system and method for users to communicate with one another via electronic messaging. An email message having one or more inquiries/questions or other type of solicitation is sent from an originator, and directed to one or more recipients. Upon receipt, the email message is opened by the recipient(s). The email message has an action button or similar indicator adjacent to an inquiry/question in the received email, the action button indicating that a response is being solicited by the originator. The recipient mouse clicks or otherwise selects the action button, which causes a template to be displayed in the same window as the received email. This template may optionally contain the original inquiry/question. A space is provided in the template for the recipient to provide a response to the inquiry/question. Because of these action buttons, the recipient is able to quickly and easily provide a response in this template, and then send the response to the originator. In addition, if any template response field is left blank, either intentionally or inadvertently, the system automatically prompts the user to supply to missing response, or to confirm that the user does not intend to provide a response.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a representative original email message sent from a sender/originator to a recipient/responder, and includes action buttons associated with inquiries contained in the email message;

FIG. 2 depicts a representative response to a first inquiry contained in the original email message;

FIG. 3 depicts a representative response to a second inquiry contained in the original email message;

FIG. 4 depicts a representative response to a third inquiry contained in the original email message, including a responder inquiry;

FIG. 5 depicts a response email containing information from the original email and embedded responses provided by the responder;

FIG. 6 depicts a representative response to the responder's inquiry;

FIG. 7 illustrates a sender's response email responsive to the responder's inquiry shown in FIG. 5;

FIGS. 8a-8c depict processing steps for processing emails in accordance with the present invention.

FIG. 9 depicts a pictorial representation of a network of data processing systems in which the present invention may be implemented.

FIG. 10 is a block diagram illustrating a data processing system that may be implemented as a server, such as the server shown in FIG. 9.

FIG. 11 is a block diagram illustrating a data processing system that may be implemented as a client computer, such as the client computer shown in FIG. 9.

### DETAILED DESCRIPTION OF THE PREFERRED EMBODIMENT

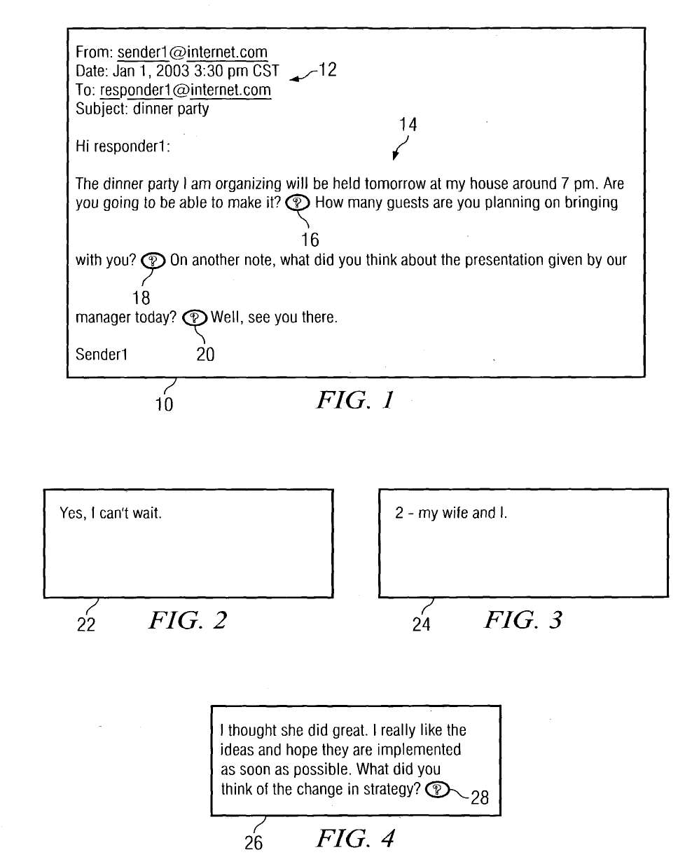

Referring now to FIG. 1, there is depicted an exemplary email message 10. The upper portion of the email message typically, but not necessarily, contains various administration information 12 regarding the email, such as the sender of the email message, the date the email message was sent, the email address or user name to whom the email is being sent to, and a subject line. Following administration information 12 is the text 14 of the email message, and may contain various inquiries/questions or other type of solicitation that the sender is asking or requesting of the recipient. For example, in this email message there are three questions: ‘Are you going to be able to make it?’; ‘How many guests are you planning on bringing with you?’; and ‘On another note, what did you think about the presentation given by our manager today?’. The present invention seeks to simplify the task of responding to such email inquiries/questions, and make email threads clearer to understand. Accordingly, action items or buttons 16, 18 and 20 are embedded in the email adjacent to the inquiries/questions contained therein. These action items denote that a specific response is expected from the email recipient. When invoked by the recipient, these action items provide a mechanism to perform the action, as will be further described below. The action items make it clear that the sender is expecting a response from the recipient. In addition, the action items make it easier for the recipient/responder to give such a response to the originator/sender.

If the responder selects the action item in the email, such as by selection using a mouse or other input device—such as a touch screen, pointing device, keyboard, touch pad or the like—a dialog box or template 22 such as that shown in FIG. 2 is presented to the responder. The responder is then able to quickly answer the question associated with the selected action item 16. Similarly, when the responder selects action item 18, dialog box 24 as shown in FIG. 3 is presented to the responder, allowing the responder to answer the particular question associated with action item 18.

In addition to the above, the system also allows the responder to include questions in their response, where the responder expects a response to their own question(s) that are included in their response. For example, referring to FIGS. 1 and 4, the responder selects action item 20 to provide a response to the question associated with such action item. Dialog box 26 as depicted in FIG. 4 is presented to the responder, who then fills in the box with an appropriate response. This response also includes a question from the responder of ‘What did you think of the change in strategy?’ which the respondent wishes to ask the sender of the email. An action item 28 associated with this question is included in the response contained in dialog box 26, in order to make it easy for the original sender to respond to the responder's question(s) upon receipt of the response email. Thus, the use of these action items improves the clarity of the email exchange for both the sender(s) and receiver(s) of the email message(s).

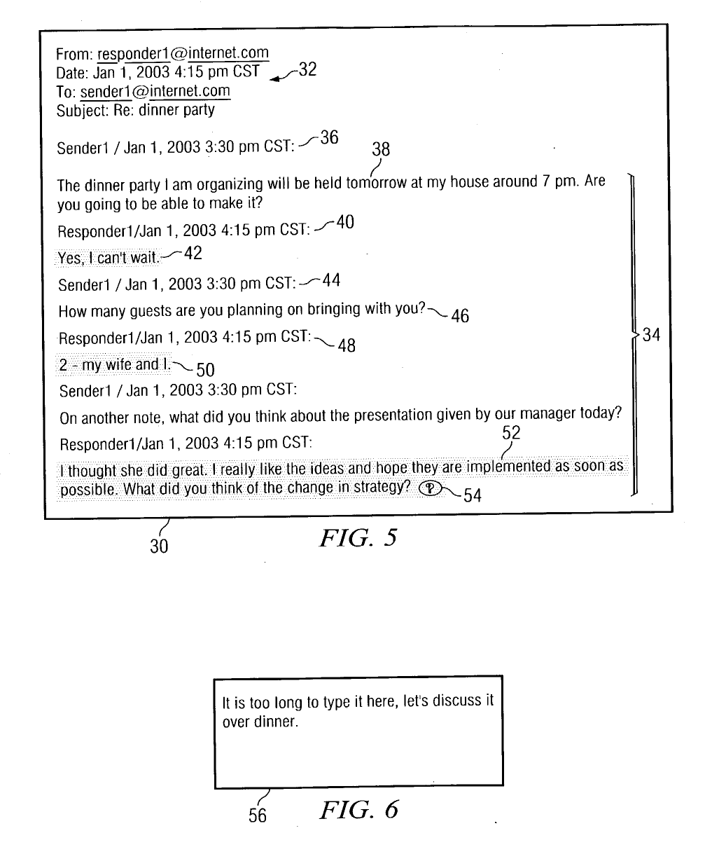

At this point, the recipient has completed responses to all the action items in the sender's email, and is ready to send the responses back to the sender. The recipient requests that the response email be generated, and sent to the sender. This can be done either in one step or two. In the one step mode of operation, the user selects a SEND (or similar) button or menu item which automatically generates the email message (as depicted in FIG. 5) and sends the message to the sender. Alternatively, the user selects a GENERATE (or similar) button or menu item which generates the response email message (as depicted in FIG. 5), and displays this response email message to the recipient prior to actually sending the message. The recipient can then optionally review the entire responding email message to confirm it is what should be sent, and then the recipient selects a SEND (or similar) button or menu item to send the message to the sender.

The response email message as generated by the responder is shown in detail at 30 in FIG. 5. The upper portion of the email message typically, but not necessarily, contains various administration information 32 regarding the email, such as the sender of the email message (who in this instance is the original responder), the date the response email message was sent, the email address or user name to whom the email is being sent to (who in this instance is the original sender), and a subject line. Following administration information 32 is the text 34 of the response email message 30. There are numerous features of this responding text information that improve the email communications efficiency. The sender's original question or inquiry which had an action item associated therewith, is automatically included in the response, as shown at 38. The originator of this question/inquiry is also identified at 36, including both the user name/identifier as well as the time this question/inquiry was originally sent. Including this user identifier and time/date stamp helps organize and keep track of who sent what to whom, and when. This is particularly useful when there are more than two individuals involved in the email exchanges, or when there are numerous back and forth exchanges of inquiry/responses in the email thread. After question 38, the responder's identity/timestamp and response are shown at 40 and 42, respectively. The timestamp portion of 40 is the time and date that the responder sent the response email to the original sender, which in this case is the same as the time and date included in the administrative area 32. In the preferred embodiment, this response 42 is also highlighted in color or the like to allow the original sender to quickly locate the response(s) to the sender's inquiries.

The detailed email response 34 includes the next inquiry at 46 from the original sender (preceded by the original sender's identity and timestamp, as shown at 44), followed by the responder's identity/timestamp and response at 48 and 50. This interleaved question/response continues for the remaining questions that were contained in the original email from the sender.

At the end of detailed email response 34, there is shown at 52 the responder's response to one of the originator's inquiries. This response also contains an inquiry of its own, the inquiry being made in this response email 30 by the original responder to the original sender. Thus, an action item 54 associated with this responder's inquiry is also included in this response email, in order to allow the original sender—upon receipt of this response email—to select the action item and receive a response prompt in similar fashion as the responder did upon receipt of the original email message 10.

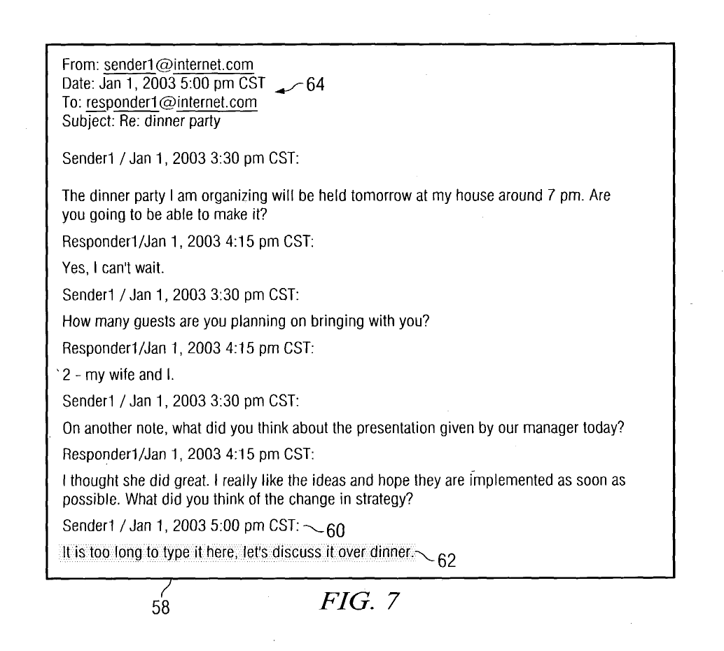

In particular, upon receipt of the response email 30 by the original sender, and selection of the action item 54 by mouse or similar fashion, a dialog box or template as shown at 56 in FIG. 6 is displayed to the original sender, who can then enter their response to the responder's inquiry contained in response 52 (FIG. 5). That being the only new inquiry contained in response email 30, the sender would then initiate generating/sending their response email that includes the response contained in dialog box/template 56. This would again be either a one-step (automatic email generation and send) or two-step (generate and preview email, with subsequent send) process, with the generated email 58 being shown in FIG. 7. This sender response provided in dialog template 56 of FIG. 6 is shown at 62 of FIG. 7, and is preceded by responder's identity/timestamp 60 (which in this case in the original sender) and the time/date of this response 58 (which matches the time/date included in administrative area 64). Response 62 is highlighted in color or similar fashion to show that it is new to the email thread. The other, previously highlighted responses are no longer highlighted as they are not new to this particular response email 58.

It should be noted that the dialog box/template such as that shown at 22, 24, 26 and 56 in FIGS. 2, 3, 4 and 6, respectively, can optionally include the inquiry/question that is being answered, to further improve end user usability.

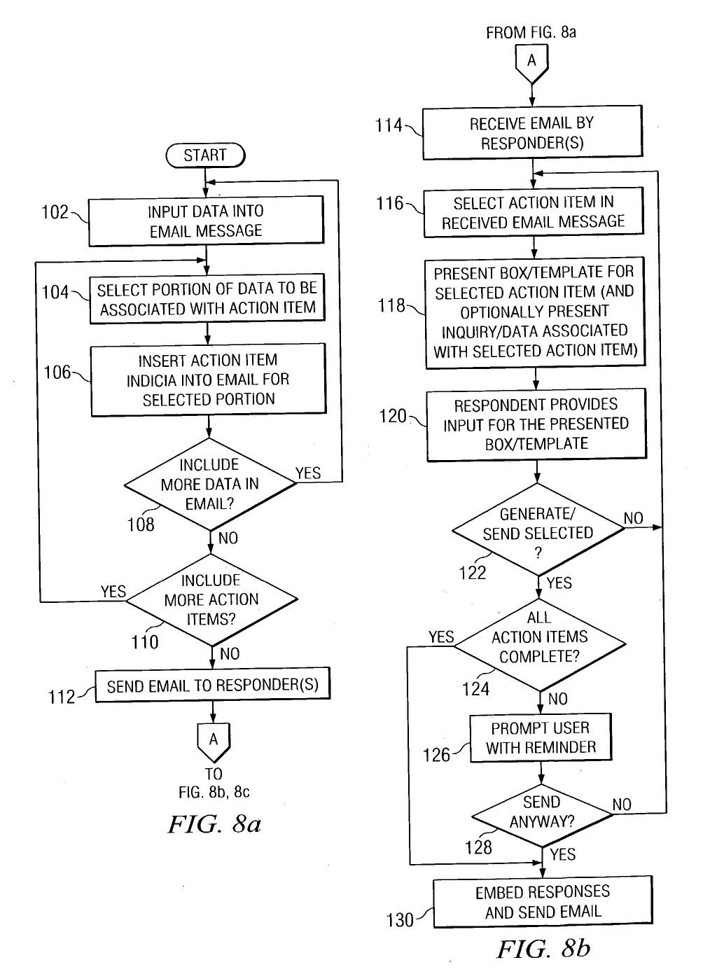

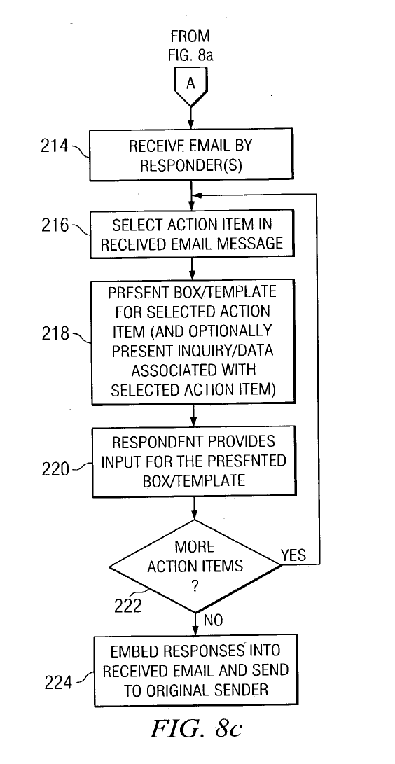

The overall system operation will now be described with reference to FIGS. 8a-8c. Referring initially to FIG. 8a, a user such as sender 1 begins inputting data into an email message, such as text, images or the like at 102. At some point, the inputted data will contain an inquiry/question or other solicitation to be posed to the recipient/respondent of the email message. At step 104, the user selects the portion of inputted data containing the inquiry, such as by using a mouse or other input device to highlight the desired data containing the inquiry. Next, at step 106, the user inserts an action item indicia such as an action button proximate the selected portion. This may be accomplished by right clicking the mouse button over the highlighted selection and selecting an appropriate action command from a drop down menu. The correlation between an action item indicia and its associated inquiry is maintained in the email file as a label or embedded link, as described in U.S. Pat. No. 6,185,555, which is hereby incorporated by reference as background material. At this point, the user can continue inputting more data into the email message, as determined by decision block 108, and if so, repeating the above steps. If no more data is to be input into the email message, the user determines at 110 if more action item indicia need to be included in the email message, such as when there are more inquiries in the data that has already been input into the email message. If so, the user continues to select inquiries and assign-action item indicia(s) as previously described. It should be noted that the order of the user determinations at decision points 108 and 110 are not critical, and can be reversed. In other words, the user can either associate action items with data each time an inquiry or other relevant data is input into the message, or the user can input data containing numerous inquiries/relevant data, and then go back and associate the individual inquiries/relevant data with their corresponding action items. Once the email message composition is completed, including association of data portions with action items, the email message is sent to one or more recipients/respondents at step 112.

Processing within the recipient side of the email exchange system is shown in FIG. 8b, where the email is originally received at step 114. The recipient/respondent then selects an action item indicia that has been included in the email message at 116, such as by a mouse click or similar input device selection. A box or template for providing a response to the inquiry associated with the selected action item indicia is then presented to the user at 118, such that the responding user can conveniently respond to the selected action item. The respondent then inputs a response to the presented dialog box/template at 120. If more action item indicia exist, the user may repeat steps 116, 118 and 120.

It is possible that the user may select a GENERATE/SEND email command prior to selecting all action items, or prior to completing all responses associated therewith. An optional-feature of the system will check for such a situation, and prompt the user with a warning message that not all action items have been completed. The user can then either choose to continue selection of the uncompleted action item(s), or alternatively, to go ahead and send the message with incomplete action items. Alternatively, the system could force the responder to reply to all action items before allowing the email message to be sent. To implement this optional checking feature, the system monitors for a GENERATE/SEND email command selection at 122, and checks to see if all action items have been responded to or completed at 124. If not, the system displays a warning prompt to the user at 126 indicating that there are incomplete action items or responses, and inquires whether or not to send the email message at 128. Depending on the response, the system either goes ahead and sends the incomplete response at 130, or continues with the action item indicia selection at 116. This feature advantageously ensures that the user hasn't inadvertently missed selection and response to one or more of the embedded action items in the received email message. Once all action items have been selected and responded to, the responses from the dialog boxes/templates are embedded into the received email and sent as a response email (such as that shown in FIG. 5) to the sender at step 130.

As part of entering a specific response in step 120 of FIG. 8b, it is also possible for the responder to include an inquiry and associated action item indicia in similar fashion to that described above regarding the original sender message. The responder would perform the same steps as previously described in FIG. 8a, including inputting the response, selecting what portion of the response input should be associated with an action item, and including the action item indicia in the response.

In an alternate embodiment to that shown in FIG. 5b, the receiving system could automatically scan the received email to determine if any action items are contained therein, and automatically present a dialog box or template for any such action items that are found. In this case, since the user didn't initiate the action item selection, the original inquiry should also be presented to the user along with, or as part of, the dialog box/template so that the user knows what it is they are responding to. It is also preferably to present the full text of the email message to the user in this automated action item selection mode, such that the inquiries can be answered by the respondent in the proper context based upon the content of the entire email message. The steps for such an automated action item scan are shown in FIG. 8c. An action item automatically detected in the received email is selected at step 216. A dialog box/template for the selected action item is presented to the user at step 218, and the respondent provides input at step 220. The responder can also include their own inquiries/action items, in similar fashion to that previously described regarding step 120 of FIG. 8b. This process is continued until all action items have been completed, as determined at step 222. The responses from the dialog boxes/templates are then embedded into the received email, and sent to the original sender at step 224.

In addition to providing responses to the embedded email action items, the responder may want to include other types of information or data into the response email. For example, the responder may want to interject a comment, make a correction, or provide additional information where the sender has not placed an action item. To accomplish this, the user would position the cursor at the appropriate location within the response email (after the response email has been generated but prior to being sent), input the desired other information/data, highlight it, and flag it appropriately such as by right clicking a mouse button over the highlighted area and choosing an information type from a drop down menu. This additional information/data would then be included in the response email with appropriate flags, highlighting, legends, or buttons similar to the previously described action item buttons to indicate the special nature of the additional information/data being provided by the responder.

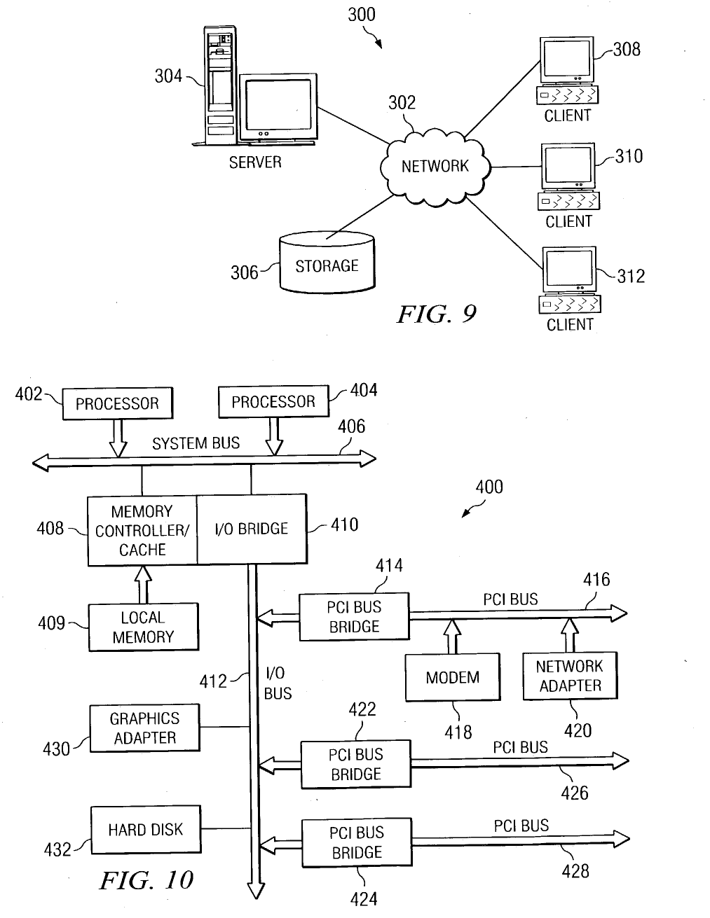

FIG. 9 depicts a pictorial representation of a network of data processing systems in which the present invention may be implemented. Network data processing system 300 is a network of computers in which the present invention may be implemented. Network data processing system 300 contains a network 302, which is the medium used to provide communications links between various devices and computers connected together within network data processing system 300. Network 302 may include connections, such as wire, wireless communication links, or fiber optic cables.

In the depicted example, server 304 is connected to network 302 along with storage unit 306. In addition, clients 308, 310, and 312 are connected to network 302. These clients 308, 310, and 312 may be, for example, personal computers or network computers. In the depicted example, server 304 provides data, such as boot files, operating system images, and applications to clients 308-312. Clients 308, 310, and 312 are clients to server 304. Network data processing system 300 may include additional servers, clients, and other devices not shown. In the preferred embodiment, the sender and responder processes described above with reference to FIGS. 8a-8c would operate on client computers such as 308, 310 and 312. However, it is also possible that one or more of the sender or responder processes operate on one or more servers such as server 104. In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks, such as for example, an intranet, a local area network (LAN), or a wide area network (WAN). FIG. 9 is intended as an example, and not as an architectural limitation for the present invention.

Referring to FIG. 10, a block diagram of a data processing system that may be implemented as a server, such as server 304 in FIG. 9, is depicted in accordance with a preferred embodiment of the present invention. Data processing system 400 may be a symmetric multiprocessor (SMP) system including a plurality of processors 402 and 404 connected to system bus 406. Alternatively, a single processor system may be employed. Also connected to system bus 406 is memory controller/cache 408, which provides an interface to local memory 409. I/O bus bridge 410 is connected to system bus 406 and provides an interface to I/O bus 412. Memory controller/cache 408 and I/O bus bridge 410 may be integrated as depicted.

Peripheral component interconnect (PCI) bus bridge 414 connected to I/O bus 412 provides an interface to PCI local bus 416. A number of modems may be connected to PCI local bus 416. Typical PCI bus implementations will support four PCI expansion slots or add-in connectors. Communications links to clients 308-312 in FIG. 9 may be provided through modem 418 and network adapter 420 connected to PCI local bus 416 through add-in boards.

Additional PCI bus bridges 422 and 424 provide interfaces for additional PCI local buses 426 and 428, from which additional modems or network adapters may be supported. In this manner, data processing system 400 allows connections to multiple network computers. A memory-mapped graphics adapter 430 and hard disk 432 may also be connected to I/O bus 412 as depicted, either directly or indirectly.

Those of ordinary skill in the art will appreciate that the hardware depicted in FIG. 10 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 10 may be, for example, an IBM eServer pSeries system, a product of International Business Machines Corporation in Armonk, N.Y., running the Advanced Interactive Executive (AIX) operating system or LINUX operating system.

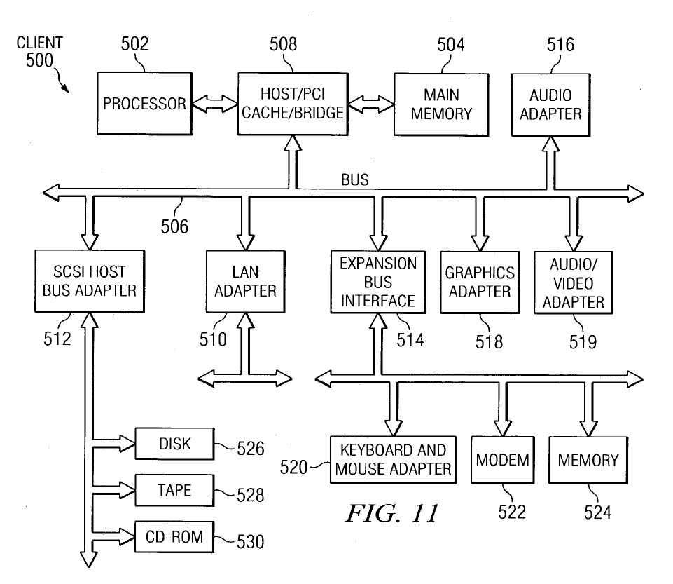

With reference now to FIG. 11, a block diagram illustrating a data processing system is depicted in which the present invention may be implemented. Data processing system 500 is an example of a client computer. Data processing system 500 employs a peripheral component interconnect (PCI) local bus architecture. Although the depicted example employs a PCI bus, other bus architectures such as Accelerated Graphics Port (AGP) and Industry Standard Architecture (ISA) may be used. Processor 502 and main memory 504 are connected to PCI local bus 506 through PCI bridge 508. PCI bridge 508 also may include an integrated memory controller and cache memory for processor 502. Additional connections to PCI local bus 506 may be made through direct component interconnection or through add-in boards. In the depicted example, local area network (LAN) adapter 510, SCSI host bus adapter 512, and expansion bus interface 514 are connected to PCI local bus 506 by direct component connection. In contrast, audio adapter 516, graphics adapter 518, and audio/video adapter 519 are connected to PCI local bus 506 by add-in boards inserted into expansion slots. Expansion bus interface 514 provides a connection for a keyboard and mouse adapter 520, modem 522, and additional memory 524. Small computer system interface (SCSI) host bus adapter 512 provides a connection for hard disk drive 526, tape drive 528, and CD-ROM drive 530. Typical PCI local bus implementations will support three or four PCI expansion slots or add-in connectors.

An operating system runs on processor 502 and is used to coordinate and provide control of various components within data processing system 500 in FIG. 11. The operating system may be a commercially available operating system, such as Windows XP, which is available from Microsoft Corporation. An object oriented programming system such as Java may run in conjunction with the operating system and provide calls to the operating system from Java programs or applications executing on data processing system 500. “Java” is a trademark of Sun Microsystems, Inc. Instructions for the operating system, the object-oriented operating system, and applications or programs are located on storage devices, such as hard disk drive 526, and may be loaded into main memory 504 for execution by processor 502.

Those of ordinary skill in the art will appreciate that the hardware in FIG. 11 may vary depending on the implementation Other internal hardware or peripheral devices, such as flash read-only memory (ROM), equivalent nonvolatile memory, or optical disk drives and the like, may be used in addition to or in place of the hardware depicted in FIG. 11. Also, the processes of the present invention may be applied to a multiprocessor data processing system.

As another example, data processing system 500 may be a stand-alone system configured to be bootable without relying on some type of network communication interfaces. As a further example, data processing system 500 may be a personal digital assistant (PDA) device, which is configured with ROM and/or flash ROM in order to provide non-volatile memory for storing operating system files and/or user-generated data.

The depicted example in FIG. 11 and above-described examples are not meant to imply architectural limitations. For example, data processing system 500 also may be a notebook computer or hand held computer in addition to taking the form of a PDA. Data processing system 500 also may be a kiosk or a Web appliance.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. For example, instead of presenting a dialog box/template to a user when an action item indicia has been selected, it is possible to display the received email message in the active window that the user is interacting with, with a blank space added after the particular question associated with the selected action item indicia, and the cursor positioned at the beginning of the blank space, such that the responding user enters their response directly into the received email at a location immediately following a particular question. In addition, the action requests or items do not have to be limited to questions/inquiries, but can also include a to-do list, calendar events, reminders, or other types of solicitation. The action requests or items can also be set to provide a choice of acceptable answers in the dialog box/template, so that the responder does not have to enter text, or alternatively, cannot enter text but must choose one of the predefined acceptable answers. For example, the responder may be presented with a list of appropriate responses such as Yes or No, True or False, or a number between 1 and 5.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMS, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

What is claimed is:

1. A method of processing an electronic message having at least one action request, comprising the steps of:
displaying the electronic message, the electronic message having an action indicia associated with the at least one action request; and
responsive to the action indicia being selected, displaying a dialog template to allow a user to respond to the at least one action request.

2. The method of claim 1, wherein the dialog template contains at least one inquiry and at least one field for responding to the at least one inquiry.

3. The method of claim 1, wherein the at least one action request is a plurality of action requests, each one of said plurality of action requests having an associated action indicia.

4. The method of claim 1, further comprising the step of inserting a response from the dialog template into the electronic message.

5. The method of claim 4, wherein the response is inserted after its corresponding action request.

6. The method of claim 4, wherein the response is preceded by a responding user identifier.

7. The method of claim 6, wherein the response is also preceded by a time/date stamp.

8. The method of claim 4, wherein the response includes a responder action indicia associated with a responder action request.

9. The method of claim 9, further comprising the step of responsive to the responder action indicia being selected, displaying another dialog template to allow another user to respond to the responder action request.

10. A method of generating an electronic message, comprising the steps of:
inputting at least one action request into the electronic message; and
generating an action indicia for the at least one action request.

11. The method of 10, further comprising the steps of selecting the at least one action request and choosing an appropriate action to be associated with the action indicia.

12. The method of claim 10, wherein the at least one action request is a question.

13. The method of claim 10, wherein the at least one action request is a calendar event.

14. The method of claim 10, wherein the at least one action request is a to-do item.

15. The method of claim 10, wherein the at least one action request is a reminder item.

16. An electronic messaging method, comprising the steps of:
generating an action indicia in an electronic message for at least one action request contained in the electronic message;
sending the electronic message by an originator to at least one recipient;
receiving the electronic message by the at least one recipient; and
responsive to the action indicia being selected, displaying a dialog template to allow the at least one recipient to respond to the at least one action request.

17. The method of claim 16, further comprising the step of:
sending to the originator a response email containing a response to the at least one action request.

18. The method of claim 17, wherein the response email further comprises the electronic message.

19. The method of claim 18, wherein the response is inserted after its corresponding action request.

20. The method of claim 18, wherein the response is preceded by a responding user identifier.

21. The method of claim 20, wherein the response is also preceded by a time/date stamp.

22. An electronic messaging method, comprising the steps of:
receiving an electronic message containing an action request and an action indicia associated with the action request;
responsive to the action indicia being selected, displaying a dialog template to allow a user to respond to the action request;
invoking a send action to send a response of the action request; and
prior to sending the response, determining if the response is incomplete, and if so, inquiring the user whether to send the incomplete response.

23. An electronic messaging system, comprising:
an electronic message having an action request contained therein; and
an action indicia proximate said action request.

24. A method of using the electronic messaging system of claim 23, comprising the steps of:
selecting the action indicia;
responsive to said selecting step, displaying a dialog template to allow a user to respond to the action request.

25. The method of claim 24, further comprising the step of inserting a response from the dialog template into the electronic message.

26. The method of claim 25, wherein the response is inserted after its corresponding action request.

27. The method of claim 25, wherein the response is preceded by a responding user identifier.

28. The method of claim 27, wherein the response is also preceded by a time/date stamp.

29. A computer program product in a computer readable medium for processing an electronic message having at least one action request, the computer program product comprising:
means for displaying the electronic message, the electronic message having an action indicia associated with the at least one action request; and
means, responsive to the action indicia being selected, for displaying a dialog template to allow a user to respond to the at least one action request.

30. A computer program product in a computer readable medium for processing an electronic message, the computer program product comprising:
means for generating an action indicia in the electronic message for at least one action request contained in the electronic message;
means for sending the electronic message by an originator to at least one recipient;
means for receiving the electronic message by the at least one recipient; and
means, responsive to the action indicia being selected, for displaying a dialog template to allow the at least one recipient to respond to the at least one action request.
